(19) United States
(12) Patent Application Publication
(10) Pub. No.: US 2014/0251231 A1
(43) Pub. Date: Sep. 11, 2014

(54) ROTATING IMPEDANCE PET PUZZLE TOY WITH TREAT RECEPTACLES

(71) Applicant: Kyle Hansen, Castle Rock, CO (US)

(72) Inventor: Kyle Hansen, Castle Rock, CO (US)

(21) Appl. No.: 13/794,439

(22) Filed: Mar. 11, 2013

(51) Int. Cl. A01K 15/02

(52) U.S. Cl. CPC A01K 15/025
USPC 119/710

(57) ABSTRACT

The invention relates to a novel pet toy wherein the pet must determine how to solve the puzzle and obtain treats located in concealed receptacles in the base portion of the toy. Treats are located in receptacles wherein retrieval may be prevented or allowed when the animal is required to remove “blocks” in order to rotate the top portion of the toy to reveal the treat receptacles. All blocks must be removed in order to rotate the top and allow access to the treats.

### FIELD

The invention relates to a novel pet toy in which treats are located in receptacles wherein retrieval may be prevented or allowed when the animal is required to remove “blocks” in order to rotate the top portion of the toy to reveal the treat receptacles.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel puzzle wherein treats are inserted into receptacles and a pet must learn to remove all of the blocks which impede rotation in order to reveal the treats.

It is well known in the animal behavior sciences that is a dog doesn't get the mental stimulation it needs it will develop Behavior problems such as chewing, biting or elimination in the home due to boredom, stress or depression. Veterinary science has also determined that in addition to behavioral problems, a dog will also be more prone to diseases as the immune system can weaken due to stress or depression. Thus it is key to challenge a dog with activities such as the inventive puzzle.

### THE INVENTION

### Summary, Objects and Advantages

All who studied any form of psychology in school remember Pavlov's Dogs. A simple conditioning test resulted in dogs remembering or being cognitive of being given a treat when a bell was rung. Thus the dogs would respond in various cognitive ways when a bell was rung. This behavior presented itself for months after the actual tests were ceased. Pavlov evidenced that dogs actually had memory and the ability to react to certain stimuli on a consistent basis.

In the inventive toy, there are four “blocks” inserted in a circular base containing receptacles for treats. There are also four scent holes to heighten the interest of the dog when treats are present. Affixed on a singular axis to the base is a rotating top piece, also circular, which exposes cut-outs for the blocks to be inserted. The blocks simply rest in the cut-outs via normal gravity.

Located in the center, and affixing the top piece to the base piece is a single point axis which controls the rotating action of the top piece. The toy may be made more or less difficult to solve with the aid of a tightening knob located underneath the toy wherein adjustment may make the top piece casing more difficult to turn. This functions to enable smaller or larger dogs to use the toy depending upon their size and obvious strength variations.

A pet owner may insert treats in any number of the four treat receptacles. The blocks must all be removed in order for the top piece to rotate and thus allow access to the treats in the receptacles. This requires keen cognitive and reasoning skills on the dog's part as removing only one block will not allow rotation and ultimately access to the treats. Further, the top piece must be rotated sufficiently to expose the treat receptacles which are located next to the block depressions, and not within them.

The inventive puzzle toy can keep a dog engaged for quite some time as it processes the methods required to expose all of the treats. One might think that a wise dog would simply flip the entire toy over, but animal behaviorists have found dogs to be a bit more complex.

### BRIEF DESCRIPTION OF THE DRAWINGS

The invention is described in further detail by reference to three drawings sufficient in detail to describe the invention in which:

FIG. 1 is a perspective view of the toy showing all blocks in situ;

FIG. 2 is a perspective view showing blocks removed and the depressions therefore in the base piece; and

FIG. 3 illustrates the toy with the top piece having been rotated sufficiently to expose treat receptacles.

### DETAILED DESCRIPTION, INCLUDING BEST MODES OF CARRYING OUT THE INVENTION

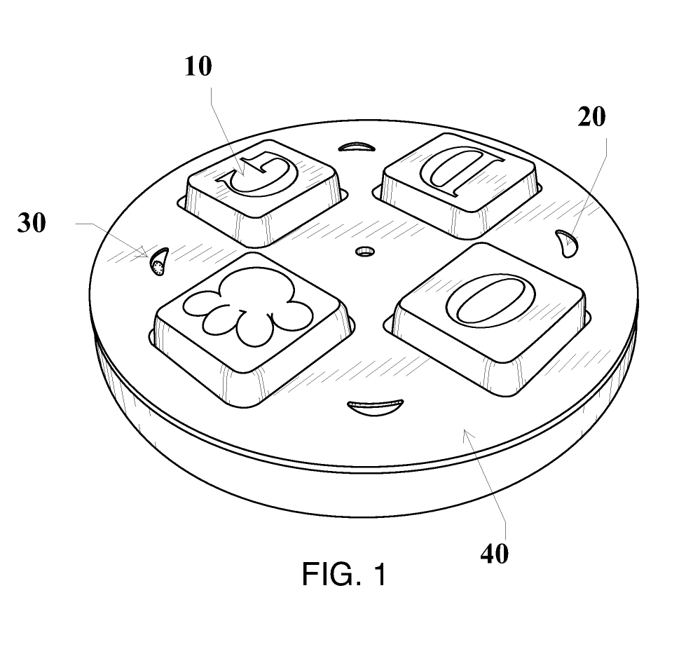

FIG. 1 illustrates the toy with all blocks in situ 10. The scent holes 20 are also shown and a small portion of a treat can be seen 30 within one scent hole. In the present view, the animal can smell the treat, but cannot access it as the blocks are impeding spinning of the top piece 40 of the toy

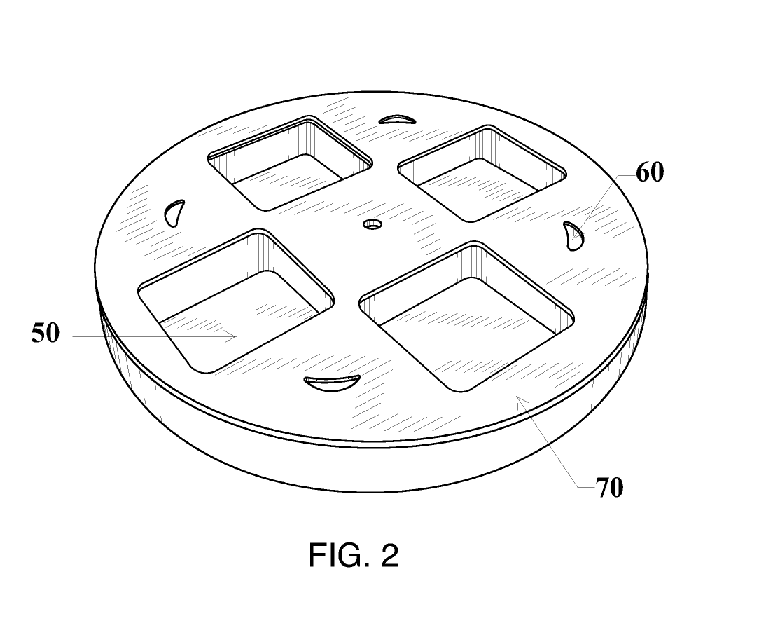

FIG. 2 is shown with the block depressions 50 with the blocks removed. In this view the scent holes 60 are also exposed. The top piece 70 is still centered above the block receptacles and thus the treat receptacles are not exposed. Now that there is no impedance, the top piece 70 may be rotated by the animal.

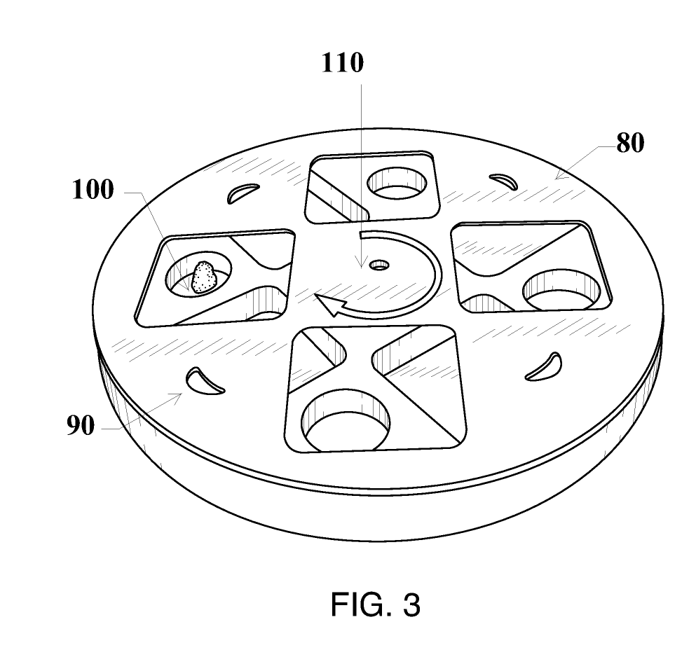

FIG. 3 illustrates how the toy will appear when the blocks have been removed, and the top piece 80 has been rotated by an animal. The treat holes 90 are now off kilter to the treat receptacles 100 which now allows the pet to see and retrieve the treat inserted therein. The center axis point 110 allows rotation in a clockwise manner. Not shown is a knob located underneath the base piece which connects to the center axis and allows for tightening of the spinning action if desired for stronger or weaker animals.

1) A rotating impedance pet puzzle toy with treat receptacles comprising;
a) a base piece
b) a circular rotating top piece
c) blocks to provide impedance
d) receptacles for treat containment
e) an axis point and knob for tightening or loosening the top piece

2) A pet puzzle toy as in claim 1 wherein the base piece is a circular shape with means to affix a top circular rotating piece.

3) A pet puzzle toy as in claim 1 wherein the top portion comprises a flat circular piece which will rotate around the axis point connected to the base piece.

4) A pet puzzle toy as in claim 1 wherein four blocks are used to insert into the top piece and seat into the base piece to provide impedance of rotation of the top piece.

5) A pet puzzle toy as in claim 1 wherein the base piece has indented receptacles for placing treats therein.

6) A pet puzzle toy as in claim 1 wherein a tightening knob is located underneath the base portion of the axis point for increasing or decreasing force required to rotate the circular top piece.
